(19) United States
(12) Patent Application Publication
(10) Pub. No.: US 2025/0309227 A1
(43) Pub. Date: Oct. 2, 2025

(54) NEGATIVE ELECTRODE FOR LITHIUM METAL SECONDARY BATTERY AND METHOD FOR MANUFACTURING NEGATIVE ELECTRODE

(71) Applicant: HONDA MOTOR CO., LTD., Tokyo (JP)

(72) Inventors: Takaharu HIRUMA, Tokyo (JP); Kazuki SAIMEN, Saitama (JP)

(21) Appl. No.: 19/058,033

(22) Filed: Feb. 20, 2025

(30) Foreign Application Priority Data
Mar. 30, 2024 (JP) 2024-058362

(51) Int. Cl. H01M 4/04; H01M 4/02; H01M 4/134; H01M 4/1395

(52) U.S. Cl. CPC H01M 4/0435; H01M 4/134; H01M 4/1395; H01M 2004/021; H01M 2004/027

(57) ABSTRACT

A method for manufacturing a negative electrode according to an embodiment of the present invention for a lithium metal secondary battery includes pressing a recess-and-projection transfer material in which a plurality of recesses having a diameter falling within a range of 2 μm or more and 20 μm or less and a depth of 12 μm or less are arranged against a surface of a laminate on a lithium-containing metal layer side, the laminate including a negative electrode current collector and a lithium-containing metal layer arranged on at least one of surfaces of the negative electrode current collector, and forming recesses and projections on a surface of the lithium-containing metal layer.

This application is based on and claims the benefit of priority from Japanese Patent Application No. 2024-058362, filed on 30 Mar. 2024, the content of which is incorporated herein by reference.

### BACKGROUND OF THE INVENTION

### Field of the Invention

The present invention relates to a negative electrode for a lithium metal secondary battery and a method for manufacturing the negative electrode.

### Related Art

In recent years, research and development on secondary batteries that contribute to increased energy efficiency has been conducted in order to enable more people to ensure access to reasonable, reliable, sustainable, and advanced energy. Lithium metal secondary batteries are known as high-capacity secondary batteries. A lithium metal secondary battery is a battery in which lithium ion is used as a charge transfer medium and in which lithium ion is deposited on a lithium-containing metal layer of a negative electrode during charging to produce a lithium metal layer, and lithium ion released from the lithium metal layer is occluded in a positive electrode during discharging.

As the negative electrode of the lithium metal secondary battery, a laminated type negative electrode including a negative electrode current collector and a lithium layer arranged on at least one of surfaces of the negative electrode current collector is known. For this laminated type negative electrode, it has been studied to provide recesses and projections on a surface of the lithium layer (Patent Document 1).
Patent Document 1: Japanese Unexamined Patent Application, Publication No. H07-272726

### SUMMARY OF THE INVENTION

One of challenges in technologies concerning the secondary batteries is to improve high-rate performance. In particular, improvement of high-rate performance of a lithium metal secondary battery immediately after being manufactured is also effective for shortening the time of a charging rate during aging. In order to improve reactivity of a lithium metal-containing layer of a negative electrode for a lithium metal secondary battery, it is effective to improve wettability of the lithium metal-containing layer with respect to an electrolytic solution by forming recesses and projections on a surface of the lithium metal-containing layer. In order to improve wettability of the lithium metal-containing layer, it is necessary to form minute recesses and projections. However, according to the studies conducted by the inventors of the present invention, when minute recesses and projections are formed on the surface of the lithium metal-containing layer by a method of pressing a recess-and-projection transfer material against the surface of the lithium metal-containing layer, the lithium metal-containing layer may adhere to a surface of the recess-and-projection transfer material to cause a loss of part of the lithium metal-containing layer. Moreover, the lithium metal-containing layer separated from the recess-and-projection transfer material may be deformed into a curled shape having a cross section curved into a semi-circular shape, and it may be difficult to use the lithium metal-containing layer for the negative electrode for a lithium metal secondary battery.

The present invention has been made in view of the above-described circumstances and has an object to provide a negative electrode for a lithium metal secondary battery, the negative electrode including a lithium-containing metal layer having high wettability with respect to an electrolytic solution, and a manufacturing method for manufacturing the negative electrode for a lithium metal secondary battery industrially advantageously. This in turn contributes to increased energy efficiency.

The inventors of the present invention have found out that for the above-described challenge, a lithium-containing metal layer having recesses and projections formed by pressing a recess-and-projection transfer material in which a plurality of recesses having a diameter and a depth falling within predetermined ranges are arranged against the lithium-containing metal layer laminated on a surface of a negative electrode current collector has high wettability with respect to an organic solvent to be used as an electrolytic solution in a lithium metal secondary battery, and have completed the present invention. Therefore, the present invention provides the following.

(1) A method for manufacturing a negative electrode for a lithium metal secondary battery, the method including pressing a recess-and-projection transfer material in which a plurality of recesses having a diameter falling within a range of 2 μm or more and 20 μm or less and a depth of 12 μm or less are arranged against a surface of a laminate on a lithium-containing metal layer side, the laminate including a negative electrode current collector and a lithium-containing metal layer arranged on at least one of surfaces of the negative electrode current collector, and forming recesses and projections on a surface of the lithium-containing metal layer.

According to the method for manufacturing a negative electrode for a lithium metal secondary battery in (1), the size of the recesses arranged on the surface of the recess-and-projection transfer material falls within the above-described range. Thus, mold releasability between the lithium-containing metal layer and the recess-and-projection transfer material is high, so that the lithium-containing metal is unlikely to adhere to the recess-and-projection transfer material after being pressed against the lithium-containing metal layer. Moreover, the lithium-containing metal layer having the recesses and projections formed on the surface thereof has high wettability with respect to an electrolytic solution. Hence, a negative electrode for a lithium metal secondary battery, the negative electrode including a lithium-containing metal layer having high wettability with respect to the electrolytic solution, can be manufactured industrially advantageously.

(2) In the method for manufacturing a negative electrode for a lithium metal secondary battery as described in (1), the recesses of the recess-and-projection transfer material have a diameter falling within a range of 2 μm or more and 15 μm or less.

According to the method for manufacturing a negative electrode for a lithium metal secondary battery in (2), mold releasability between the lithium-containing metal layer and the recess-and-projection transfer material is improved further.

(3) In the method for manufacturing a negative electrode for a lithium metal secondary battery as described in (1) or (2), the recesses have a conical or semispherical shape.

According to the method for manufacturing a negative electrode for a lithium metal secondary battery in (3), recesses do not have acute edges. Thus, loss is unlikely to occur in the lithium-containing metal layer when the recess-and-projection transfer material is pressed against the lithium-containing metal layer, so that projections having edges are not formed on the surface of the obtained negative electrode for a lithium metal secondary battery. Thus, a battery in which the obtained negative electrode for a lithium metal secondary battery is used can prevent deposition of lithium that would be caused by current concentration at edges in the lithium-containing metal layer. This prevents a minute short circuit in the battery and can control the occurrence of a voltage drop failure.

(4) In the method for manufacturing a negative electrode for a lithium metal secondary battery as described in any one of (1) to (3), the recess-and-projection transfer material is formed of any of Al, Ti, Ni, W, and carbon.

According to the method for manufacturing a negative electrode for a lithium metal secondary battery in (4), a short circuit is unlikely to occur even if the material for the recess-and-projection transfer material is mixed into the negative electrode of the lithium metal secondary battery.

(5) In the method for manufacturing a negative electrode for a lithium metal secondary battery as described in any one of (1) to (4), a relationship of D≤t−2 is satisfied where t (unit: μm) represents a thickness of the lithium-containing metal layer, and D (unit: μm) represents the depth of the recesses.

According to the method for manufacturing a negative electrode for a lithium metal secondary battery in (5), the lithium-containing metal layer after formation of the recesses and projections has a thickness of 2 μm or more in a portion where the recesses and projections are not formed. Thus, the lithium-containing metal layer after formation of the recesses and projections has high strength.

(6) In the method for manufacturing a negative electrode for a lithium metal secondary battery as described in any one of (1) to (5), when the recess-and-projection transfer material is pressed against the surface on the lithium-containing metal layer side, an organic solvent or a structure is interposed between the surface on the lithium-containing metal layer side and the recess-and-projection transfer material.

According to the method for manufacturing a negative electrode for a lithium metal secondary battery in (6), mold releasability between the lithium-containing metal layer and the recess-and-projection transfer material is improved further.

(7) In the method for manufacturing a negative electrode for a lithium metal secondary battery as described in any one of (1) to (6),
the recess-and-projection transfer material is a plate-shaped body, and
the recesses are arranged on at least one of surfaces of the plate-shaped body.

According to the method for manufacturing a negative electrode for a lithium metal secondary battery in (7), the recesses and projections can be formed efficiently on the lithium-containing metal layer of the laminate adjusted to have a predetermined size because the recess-and-projection transfer material is the plate-shaped body.

(8) In the method for manufacturing a negative electrode for a lithium metal secondary battery as described in any one of (1) to (6),
the recess-and-projection transfer material is a roll-shaped body, and
the recesses are arranged on at least part of a surface of the roll-shaped body.

According to the method for manufacturing a negative electrode for a lithium metal secondary battery in (8), the recesses and projections can be continuously formed on the lithium-containing metal layer of the elongated laminate in a roll-to-roll process because the recess-and-projection transfer material is the roll-shaped body.

(9) In the method for manufacturing a negative electrode for a lithium metal secondary battery as described in any one of (1) to (8),
the lithium-containing metal layer includes lithium-containing metal layers, and the laminate has the lithium-containing metal layers laminated on both surfaces of the negative electrode current collector, respectively, and
the recess-and-projection transfer material includes the recess-and-projection transfer materials, and the recess-and-projection transfer materials are simultaneously pressed against the lithium-containing metal layers laminated on both the surfaces of the negative electrode current collector, respectively.

According to the method for manufacturing a negative electrode for a lithium metal secondary battery in (9), the lithium-containing metal layer is unlikely to be deformed because the recess-and-projection transfer materials are simultaneously pressed against the lithium-containing metal layers laminated on both the surfaces of the negative electrode current collector.

(10) In the method for manufacturing a negative electrode for a lithium metal secondary battery as described in any one of (1) to (9), a pressure with which the recess-and-projection transfer material is pressed against the surface on the lithium-containing metal layer side falls within a range of 5 MPa or more and 25 MPa or less.

According to the method for manufacturing a negative electrode for a lithium metal secondary battery in (10), the recesses and projections can be formed reliably on the surface of the lithium-containing metal layer while maintaining mold releasability between the lithium-containing metal layer and the recess-and-projection transfer material because the pressure when the recess-and-projection transfer material is pressed falls within the above-described range.

(11) A negative electrode for a lithium metal secondary battery, the negative electrode being a laminate including a negative electrode current collector and a lithium-containing metal layer arranged on at least one of surfaces of the negative electrode current collector, in which the lithium-containing metal layer has, on a surface thereof, projections having a diameter falling within a range of 2 μm or more and 20 μm or less and a height of 12 μm or less and has an angle of contact at 25° C. of 20 degrees or less with respect to a liquid having a viscosity at 25° C. of 5 mPaS or more and 12 mPaS or less.

According to the negative electrode for a lithium metal secondary battery in (11), mold releasability between the lithium-containing metal layer and the recess-and-projection transfer material is high because the size of the projections arranged on the surface falls within the above-described range. Moreover, wettability is high because the angle of contact at 25° C. is as low as 20 degrees with respect to a liquid corresponding to an electrolytic solution of a typical lithium metal secondary battery, an organic solvent constituting the electrolytic solution, or their mixed solvent and having a viscosity at 25° C. of 5 mPaS or more and 12 mPas or less. Thus, a lithium metal secondary battery in which the negative electrode for a lithium metal secondary battery in (11) is used has improved wettability of the negative electrode with respect to the electrolytic solution and can be shortened in aging time. Besides, an internal resistance of the battery is reduced, and in particular, high-rate charging performance is improved. Hence, a lithium metal secondary battery particularly adapted to rapid charging is obtained.

According to the present invention, a negative electrode for a lithium metal secondary battery, the negative electrode including a lithium-containing metal layer having high wettability with respect to an electrolytic solution, and a manufacturing method for manufacturing the negative electrode for a lithium metal secondary battery industrially advantageously can be provided.

### BRIEF DESCRIPTION OF THE DRAWINGS

FIG. 1 is a cross-sectional view of an example showing an electrode laminate in which a negative electrode according to an embodiment of the present invention for a lithium metal secondary battery is used;

FIG. 2 is a schematic view showing an example of an apparatus for manufacturing a negative electrode for a lithium metal secondary battery, for which a method for manufacturing the negative electrode according to the embodiment of the present invention for a lithium metal secondary battery can be used;

FIG. 3 is a schematic view showing another example of an apparatus for manufacturing a negative electrode for a lithium metal secondary battery, for which the method for manufacturing the negative electrode according to the embodiment of the present invention for a lithium metal secondary battery can be used; and

FIG. 4 is an SEM photograph of a surface of a recess-and-projection transfer material fabricated in Example 1.

### DETAILED DESCRIPTION OF THE INVENTION

Hereinafter, an embodiment of the present invention will be described with reference to the drawings. However, the following embodiment exemplifies the present invention, and the present invention is not limited to the following embodiment.

A negative electrode which is an embodiment of the present invention is for use in a lithium metal secondary battery. The lithium metal secondary battery includes an electrode laminate having a positive electrode and the negative electrode laminated with a separator interposed therebetween, an electrolytic solution, and an exterior body that stores the electrode laminate and the electrolytic solution.

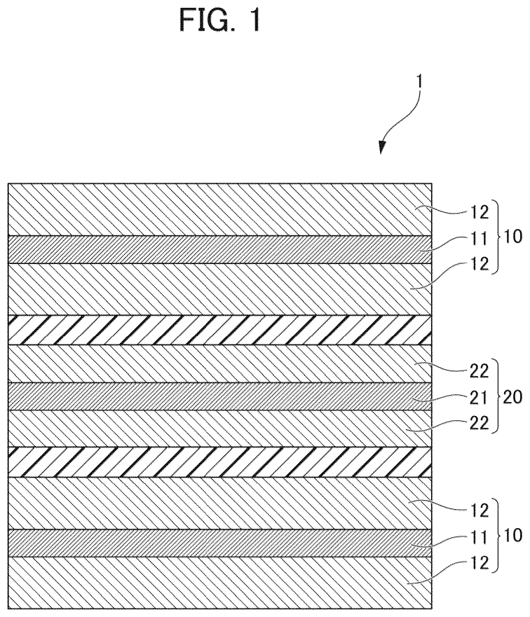

FIG. 1 is a cross-sectional view showing the electrode laminate in which the negative electrode according to the embodiment of the present invention for a lithium metal secondary battery is used. As shown in FIG. 1, an electrode laminate 1 is a laminate including a plurality of positive electrodes 10 and a plurality of negative electrodes 20 alternately laminated with separators 30 interposed therebetween.

The positive electrode 10 has a positive electrode current collector 11 and positive electrode active material layers 12 laminated on both surfaces of the positive electrode current collector 11. Examples of the material for the positive electrode current collector 11 include aluminum, aluminum alloy, stainless steel, nickel, iron, and titanium.

The positive electrode active material layer 12 contains a positive electrode active material. The positive electrode active material is a lithium compound that releases lithium ion during discharging and occludes lithium ion during charging. A layered active material, a spinel-type active material, or an olivine-type active material, for example, can be used as the lithium compound. Specific examples of the positive electrode active material include lithium cobalt oxide (LiCoO₂), lithium nickelate (LiNiO₂), lithium nickel manganese cobalt oxide (NMC: LiNiₚMn_{q}CoᵣO₂ (where p+q+r=1)), LiNiₚAl_{q}CoᵣO₂ (where p+q+r=1), lithium manganate (LiMn₂O₄), heterogeneous element substituted Li—Mn spinel represented by Li₁₊ₓMn_{2-x-y}MO₄ (where x+y=2, and M is at least one selected from Al, Mg, Co, Fe, Ni, and Zn), lithium titanate (oxides containing Li and Ti), metallic lithium phosphate (LiMPO₄, where M is at least one selected from Fe, Mn, Co, and Ni), and the like. The positive electrode active material layer 12 may additionally contain a conductive aid and a binder.

The negative electrode 20 has a negative electrode current collector 21 and lithium-containing metal layers 22 laminated on both surfaces of the negative electrode current collector 21. Examples of the material for the negative electrode current collector 21 include copper, copper alloy, nickel, and stainless steel.

Lithium ion is deposited on a surface of the lithium-containing metal layer 22 during charging to produce a lithium metal layer, and lithium of the lithium metal layer is released during discharging. Thus, the negative electrode 20 is changed in thickness by charging and discharging. The lithium-containing metal layer 22 has, on a surface thereof, projections having a diameter falling within a range of 2 μm or more and 20 μm or less and a height of 12 μm or less. The lithium-containing metal layer 22 has an angle of contact at 25° C. of 20 degrees or less with respect to a liquid having a viscosity at 25° C. of 5 mPaS or more and 12 mPaS or less. The liquid having a viscosity at 25° C. of 5 mPaS or more and 12 mPaS or less is, for example, an electrolytic solution to be used in the lithium metal secondary battery in which the negative electrode 20 is used. The angle of contact may be 10 degrees or less, or may be five degrees or less. A portion of the lithium-containing metal layer 22 excluding the projections may have a thickness of 2 μm or more. Lithium and metal that forms an alloy with lithium can be used as the material for the lithium-containing metal layer 22. Examples of the metal that forms an alloy with lithium include Mg, Si, Au, Ag, In, Ge, Sn, Pb, Al, and Zn.

A porous sheet or a non-woven fabric sheet, for example, can be used as the separator 30. Examples of the material for the porous sheet include polyolefins such as polyethylene or polypropylene, aramid, polyimide, fluorine resin, and the like. Examples of the material for the non-woven fabric sheet include fiberglass, cellulose fiber, and the like. The separator 30 preferably has an angle of contact at 25° C. of 30 degrees or less with respect to a liquid having a viscosity at 5° C. of 5 mPaS or more and 12 mPaS or less. In other words, the separator 30 preferably has low wettability with respect to an electrolytic solution or a solvent in the same manner as the lithium-containing metal layer 22. If the separator 30 has an angle of contact of 40 degrees to 60 degrees with respect to the electrolytic solution, a minute short circuit might be likely to occur.

The electrolytic solution contains an organic solvent and an electrolyte. Cyclic carbonates, chain carbonates, cyclic ethers, chain ethers, hydrofluoroethers (HFE), aromatic ethers, sulfones, cyclic esters, chain carboxylic esters, and nitriles, for example, can be used as the organic solvent. Examples of the cyclic carbonates include ethylene carbonate, propylene carbonate, vinylene carbonate, fluoroethylene carbonate, and the like. Examples of the chain carbonates include dimethyl carbonate, diethyl carbonate, ethylmethyl carbonate, and the like. Examples of the cyclic ethers include tetrahydrofuran, 2-methyltetrahydrofuran, tetrahydropyran, 1,3-dioxolane, 4-methyl 1,3-dioxolane, and the like. Examples of the chain ethers include 1,2-dimethoxyethane, 1,2-diethoxyethane, ethoxy methoxyethane, diethyl ether, and the like. Examples of the hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl)ether, 1,2-bis(1,1,2,2-tetrafluoro ethoxy)ethane, and the like. Examples of the aromatic ethers include anisole. Examples of the sulfones include sulfolane, methyl sulfolane, and the like. Examples of the cyclic esters include γ-butyrolactone, and the like. Examples of the chain carboxylic esters include acetate ester, butyrate ester, propionate ester, and the like. Examples of the nitriles include acetonitrile, propionitrile, and the like. One of the organic solvents may be used alone, or two or more of the organic solvents may be used in combination.

The electrolyte is a supply source of lithium ion, which is the charge transfer medium, and contains a lithium salt. Examples of the lithium salt include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), LiBC₄O₈, and the like. One of the lithium salts may be used alone, or two or more of the lithium salts may be used in combination. The electrolyte has a concentration falling within a range of 1.0 to 4.0 mol/L, for example.

The exterior body is capable of expanding and contracting along with changes in thickness of the negative electrode 20 through charging and discharging. A laminate film can be used as the material for the exterior body. A three-layered laminate film including an inner resin layer, a metal layer, and an outer resin layer laminated in this order from the inner side can be used as the laminate film. The outer resin layer may be a polyamide (nylon) layer or polyethylene terephthalate (PET) layer, for example. The metal layer may be an aluminum layer, for example. The inner resin layer may be a polyethylene layer or polypropylene layer, for example.

Next, a method for manufacturing the negative electrode of the present embodiment for a lithium metal secondary battery will be described.

In the method for manufacturing the negative electrode of the present embodiment for a lithium metal secondary battery, a recess-and-projection transfer material having a plurality of recesses arranged on a surface thereof is pressed against a surface of a laminate on a lithium-containing metal layer side, the laminate including a negative electrode current collector and a lithium-containing metal layer, and forming recesses and projections on a surface of the lithium-containing metal layer. The recesses of the recess-and-projection transfer material have a diameter falling within a range of 2 μm or more and 20 μm or less and a depth of 12 μm or less. The diameter of the recesses may fall within a range of 2 μm or more and 15 μm or less, or may fall within a range or 5 μm or more and 15 μm or less. The depth of the recesses may fall within a range of 2 μm or more and 15 μm or less, or may fall within a range of 4 μm or more and 12 μm or less. The depth of the recesses may satisfy a relation of D≤t−2 where t (unit: μm) represents a thickness of the lithium-containing metal layer and D (unit: μm) represents the depth of the recesses. The recesses of the recess-and-projection transfer material may have a conical or semispherical shape, for example. The recesses may have a pitch falling within a range of 4 μm or more and 50 μm or less, for example. The recess-and-projection transfer material having such recesses can be manufactured by forming recesses on a surface of a plate-shaped base material through laser machining, for example. Al, Ti, Ni, W, or carbon, for example, can be used as the material for the plate-shaped base material.

When the recess-and-projection transfer material is pressed against the surface on the lithium-containing metal layer side, an organic solvent or a structure may be interposed between the surface on the lithium-containing metal layer side and the recess-and-projection transfer material. The organic solvent or the structure may function as a mold release agent. The organic solvent may have an ether linkage or a carbonate ester linkage. DME (1,2-dimethoxyethane) or DEE (1,2-dimethoxyethane), for example, can be used as the solvent having the ether linkage. Dimethyl carbonate, for example, can be used as the solvent having the carbonate ester linkage. The structure may be arranged in a layered manner on the surface of the recess-and-projection transfer material. Fluorine resin or diamond-like carbon (DLC) can be used as the structure. These are arranged in a layered manner on the surface of the recess-and-projection transfer material to function as a mold release agent.

A pressure with which the recess-and-projection transfer material is pressed against the surface on the lithium-containing metal layer side is not particularly restricted and may fall within a range of 5 MPa or more and 25 MPa or less. The recess-and-projection transfer material may be a plate-shaped body, or may be a roll-shaped body.

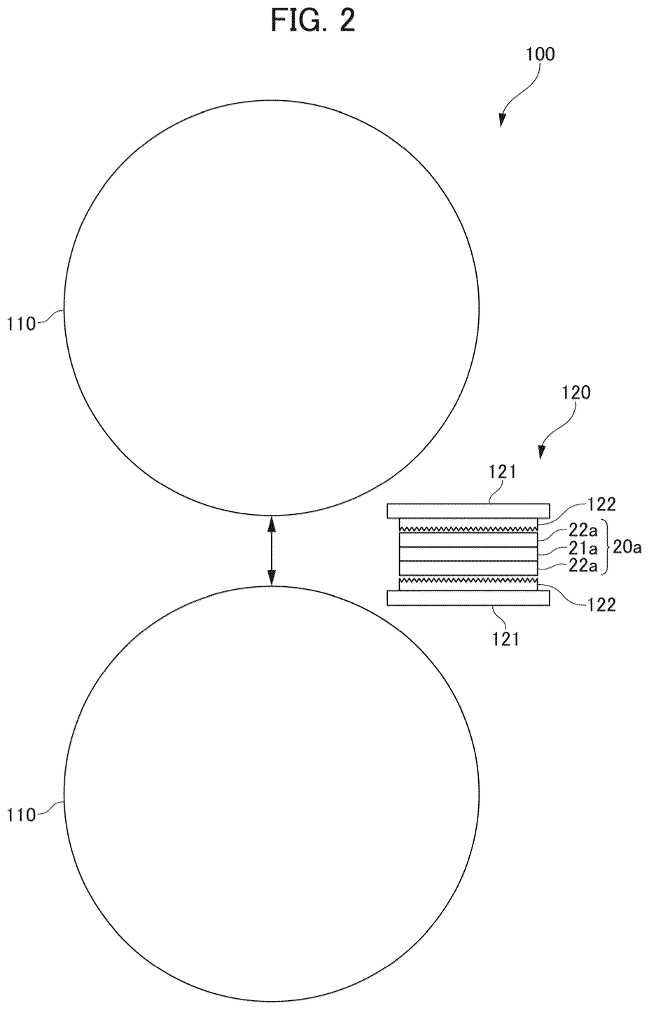

FIG. 2 is a schematic view showing an example of an apparatus for manufacturing a negative electrode for a lithium metal secondary battery, for which the method for manufacturing the negative electrode according to the embodiment of the present invention for a lithium metal secondary battery can be used.

An apparatus for manufacturing a negative electrode for a lithium metal secondary battery 100 shown in FIG. 2 includes a pair of press rolls 110 and a recess-and-projection forming laminate 120. A negative electrode material laminate 20a is used as a raw material for the negative electrode. The negative electrode material laminate 20a has a negative electrode current collector material 21a and lithium-containing metal layer materials 22a laminated on both surfaces of the negative electrode current collector material 21a. The negative electrode material laminate 20a is adjusted to have a size of the negative electrode for a lithium metal secondary battery to be manufactured. The recess-and-projection forming laminate 120 is a laminate in which plate-shaped recess-and-projection transfer materials 122 are overlapped such that surfaces thereof having the recesses are respectively in contact with surfaces of the lithium-containing metal layer materials 22a of the negative electrode material laminate 20a. The plate-shaped recess-and-projection transfer material 122 is a plate-shaped body having recesses arranged at least on one of surfaces thereof. A release plate 121 is arranged on a surface of the plate-shaped recess-and-projection transfer material 122 on the opposite side of the recesses. A copper plate, for example, can be used as the release plate 121. The recess-and-projection forming laminate 120 is pressurized by the pair of press rolls 110, thereby simultaneously forming recesses and projections on the surfaces of the lithium-containing metal layer materials 22a laminated on both the surfaces of the negative electrode current collector material 21a.

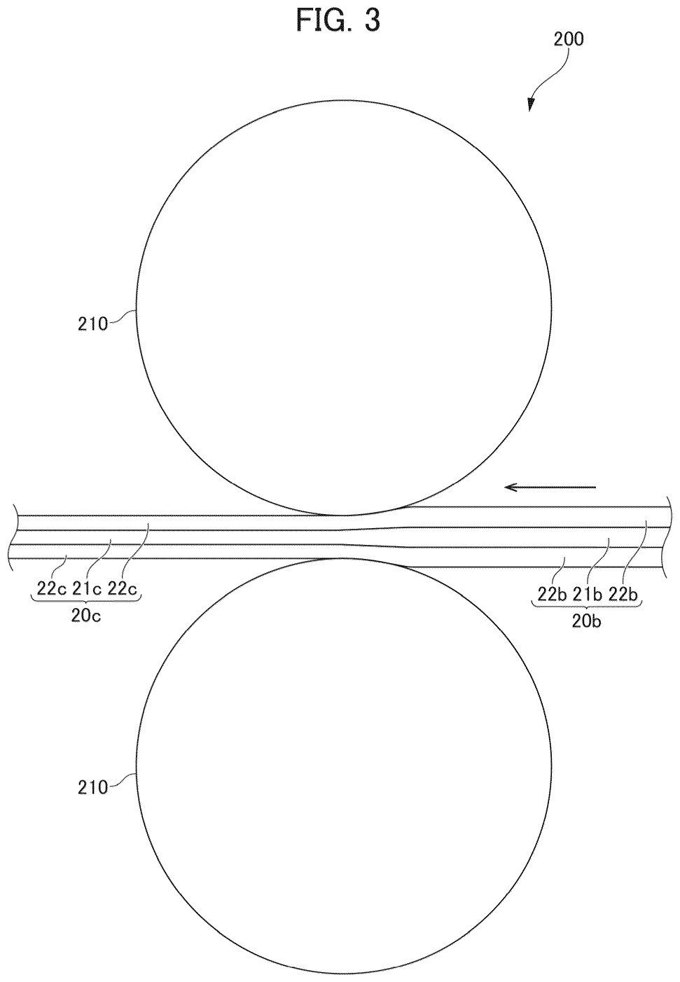

FIG. 3 is a schematic view showing an example of an apparatus for manufacturing a negative electrode for a lithium metal secondary battery, for which the method for manufacturing the negative electrode according to the embodiment of the present invention for a lithium metal secondary battery can be used.

An apparatus for manufacturing a negative electrode for a lithium metal secondary battery 200 shown in FIG. 3 includes a pair of roll-shaped recess-and-projection transfer materials 210. The roll-shaped recess-and-projection transfer material 210 is a roll-shaped body having recesses at least on part of a surface thereof. An elongated lithium-containing metal layer material sheet 20b is used as a negative electrode raw material. The elongated lithium-containing metal layer material sheet 20b has an elongated negative electrode current collector material sheet 21b and elongated lithium-containing metal layer material sheets 22b laminated on both surfaces of the elongated negative electrode current collector material sheet 21b. The elongated lithium-containing metal layer material sheet 20b is passed between the pair of roll-shaped recess-and-projection transfer materials, thereby simultaneously forming recesses and projections on surfaces of the elongated lithium-containing metal layer material sheets 22b laminated on both the surfaces of the elongated negative electrode current collector material sheet 21b, respectively. An elongated negative electrode material laminate sheet having recesses and projections 20c and including an elongated negative electrode current collector material sheet 21c and elongated lithium-containing metal layer material sheets 22c having recesses and projections and laminated on both surfaces of the elongated negative electrode current collector material sheet 21c is thereby obtained. The obtained elongated negative electrode material laminate sheet having recesses and projections 20c is adjusted to have a predetermined size and is used as a negative electrode for a lithium metal secondary battery.

According to the method for manufacturing the negative electrode of the present embodiment for a lithium metal secondary battery configured as above described, the size of the recesses arranged on the surface of the recess-and-projection transfer material (the plate-shaped recess-and-projection transfer material 122 and the roll-shaped recess-and-projection transfer material 210) falls within the above-described range. Thus, mold releasability between the lithium-containing metal layer and the recess-and-projection transfer material is high, so that the lithium-containing metal is unlikely to adhere to the recess-and-projection transfer material after being pressed against the lithium-containing metal layer. Moreover, the lithium-containing metal layer having recesses and projections formed on the surface thereof has high wettability with respect to an electrolytic solution. Hence, the negative electrode for a lithium metal secondary battery, the negative electrode including the lithium-containing metal layer having high wettability with respect to the electrolytic solution, can be manufactured industrially advantageously.

In the method for manufacturing the negative electrode of the present embodiment for a lithium metal secondary battery, the recesses are not angulated in a case in which the recesses of the recess-and-projection transfer material have a conical or semispherical shape. Thus, loss is unlikely to occur in the lithium-containing metal layer when the recess-and-projection transfer material is pressed against the lithium-containing metal layer. In the method for manufacturing the negative electrode of the present embodiment for a lithium metal secondary battery, even if the recess-and-projection transfer material is mixed into the negative electrode of the lithium metal secondary battery, a short circuit is unlikely to occur in a case in which the recess-and-projection transfer material is formed of the above-described materials. In the method for manufacturing the negative electrode of the present embodiment for a lithium metal secondary battery, in a case in which the thickness t of the lithium-containing metal layer and the depth D of the recesses of the recess-and-projection transfer material satisfy the above-described relationship, the lithium-containing metal layer after formation of the recesses and projections has a thickness of 2 μm or more in a portion where the recesses and projections are not formed. Thus, the lithium-containing metal layer after formation of the recesses and projections has high strength. In the method for manufacturing the negative electrode of the present embodiment for a lithium metal secondary battery, in a case in which an organic solvent or a structure is interposed between the surface on the lithium-containing metal layer side and the recess-and-projection transfer material when the recess-and-projection transfer material is pressed against the surface on the lithium-containing metal layer side, mold releasability between the lithium-containing metal layer and the recess-and-projection transfer material is improved further.

In the method for manufacturing the negative electrode of the present embodiment for a lithium metal secondary battery, in a case in which the recess-and-projection transfer material is the plate-shaped recess-and-projection transfer material 122, the recesses and projections can be formed efficiently on the lithium-containing metal layer of the laminate adjusted to have a predetermined size. In the method for manufacturing the negative electrode of the present embodiment for a lithium metal secondary battery, in a case in which the recess-and-projection transfer material is the roll-shaped recess-and-projection transfer material 210, the recesses and projections can be formed in a roll-to-roll process on the lithium-containing metal layer of the elongated laminate.

In the method for manufacturing the negative electrode of the present embodiment for a lithium metal secondary battery, in a case in which the pressure with which the recess-and-projection transfer material is pressed falls within the above-described range, the recesses and projections can be formed reliably on the surface of the lithium-containing metal layer while maintaining mold releasability between the lithium-containing metal layer and the recess-and-projection transfer material.

Since the size of the projections arranged on the surface of the negative electrode for a lithium metal secondary battery obtained by the method for manufacturing the negative electrode of the present embodiment for a lithium metal secondary battery falls within the above-described range, mold releasability between the lithium-containing metal layer and the recess-and-projection transfer material is high. Moreover, wettability with respect to the electrolytic solution is high because the angle of contact at 25° C. is as low as 20 degrees with respect to a liquid having a viscosity at 25° C. of 5 mPaS or more and 12 mPaS or less. Thus, the lithium metal secondary battery in which the negative electrode of the present embodiment for a lithium metal secondary battery is used has improved high-rate performance.

Although the embodiment of the present invention has been described above, the present invention is not limited to the above-described embodiment.

For example, a non-aqueous solvent lithium metal secondary battery including an electrolytic solution has been described as the lithium metal secondary battery in which the negative electrode of the present embodiment for a lithium metal secondary battery is used, but the present invention is not limited to this. The negative electrode of the present invention for a lithium metal secondary battery may be used for a solid electrolyte lithium metal secondary battery. Although the negative electrode 20 has the lithium-containing metal layers 22 laminated on both the surfaces of the negative electrode current collector 21, the negative electrode 20 may have the lithium-containing metal layer 22 laminated on one of the surfaces of the negative electrode current collector 21.

### EXAMPLES

The present invention will be described using examples. However, the present invention is not limited to the examples.

### Example 1

### (Fabrication of Negative Electrode)

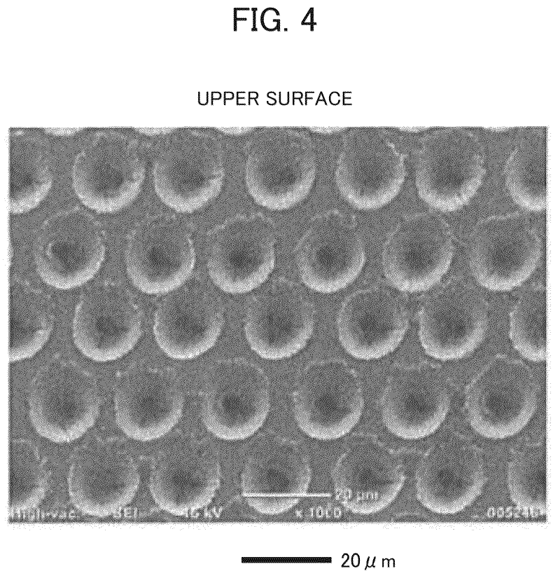

Recesses having a diameter of 15 μm and a depth of 12 μm were formed at a pitch of 20 μm on a surface of a Ti base material using laser machining to fabricate a recess-and-projection transfer material. FIG. 4 shows a scanning electron microscope (SEM) photograph of a surface of the obtained recess-and-projection transfer material. The SEM photograph in FIG. 4 reveals that the recesses on the surface of the recess-and-projection transfer material had a conical shape.

A Li—Cu laminate obtained by laminating an Li foil on one of surfaces of a negative electrode current collector made of Cu was prepared. DEE (1,2-diethoxyethane) was dropped onto the Li foil of the Li—Cu laminate. Then, a surface of the Li foil of the Li—Cu laminate and the recesses of the above-described recess-and-projection transfer material were overlapped on each other. The overlap was sandwiched between mold release copper foils having a thickness of 20 μm to obtain a recess-and-projection forming laminate in which the mold release copper foil, the Li—Cu laminate, the recess-and-projection transfer material, and the mold release copper foil were laminated in this order. The obtained recess-and-projection forming laminate was pressurized at a pressure of 25 MPa using a roll press such that a rate of compression was 30%. The mold release copper foils and the recess-and-projection transfer material were separated from the recess-and-projection forming laminate after pressurization to obtain a Li—Cu laminate having recesses and projections obtained by transferring recesses and projections to the surface of the Li foil.

### (Fabrication of Positive Electrode)

Acetylene black (AB) as an electron-conductive material and polyvinylidene fluoride (PVDF) as a binding agent (binder) were pre-mixed with N-methyl-2-pyrolidone (NMP) as a dispersion solvent. The mixture was wet-mixed using a planetary centrifugal mixer, thereby obtaining a pre-mixed slurry. Subsequently, Li1Ni_{0.8}CO_{0.1}Mn_{0.1}O₂ (NCM811) as a positive electrode active material was mixed with the obtained pre-mixed slurry, and a dispersion process was carried out using a planetary mixer, thereby obtaining a positive electrode paste. NCM811 had a median diameter of 12 μm. Next, the obtained positive electrode paste was applied to a positive electrode current collector made of aluminum, and dried. The current collector was pressurized with a roll press, and then, dried in a vacuum at 120° C. to form a positive electrode plate having a positive electrode active material layer. The obtained positive electrode plate was punched into a piece having a size of 30 mm×40 mm to obtain the positive electrode.

### (Separator)

A porous polyolefin film having a thickness of 20 μm was prepared as the separator. The angle of contact at 25° C. of this separator with respect to the following electrolytic solution was 26 degrees as a result of measurement.

### (Fabrication of Electrolytic Solution)

An electrolytic solution obtained by dissolving LiFSI at a concentration of 2.5 mol/L in 1,2-dimethoxyethane (DME) was fabricated. When the viscosity of the obtained electrolytic solution was measured using a rotational viscometer, the viscosity at 25° C. was 10 mPaS.

### (Fabrication of Lithium Metal Secondary Battery)

The Li—Cu laminate having recesses and projections was punched into a piece having a size of 34 mm×44 mm to obtain the negative electrode. The separator was overlapped on the Li foil of the negative electrode, and then the positive electrode active material layer of the positive electrode was overlapped on a surface of the separator on the opposite side of the negative electrode to fabricate an electrode laminate in which the negative electrode, the separator, and the positive electrode were laminated in this order. Then, a tab was attached to each of the positive electrode current collector and the negative electrode current collector of the obtained electrode laminate. The electrode laminate with the tabs attached thereto was input to a bag made of a laminate film, and then the electrolytic solution was input thereto. The bag made of the laminate film was sealed to fabricate a lithium metal secondary battery.

### Example 2

In the fabrication of the negative electrode, the negative electrode was fabricated in the same manner as in Example 1, except that the depth of the recesses of the recess-and-projection transfer material was 8 μm, and the lithium metal secondary battery was fabricated using the negative electrode.

### Example 3

In the fabrication of the negative electrode, the negative electrode was fabricated in the same manner as in Example 1, except that the depth of the recesses of the recess-and-projection transfer material was 4 μm, and the lithium metal secondary battery was fabricated using the negative electrode.

### Example 4

In the fabrication of the negative electrode, the negative electrode was fabricated in the same manner as in Example 1, except that the depth of the recesses of the recess-and-projection transfer material was 4 μm and except that the surface of the Li foil of the Li—Cu laminate and the recesses and projections of the recess-and-projection transfer material were overlapped on each other without dropping DEE onto the Li foil of the Li—Cu laminate, and the lithium metal secondary battery was fabricated using the negative electrode.

### Comparative Example 1

In the fabrication of the negative electrode, the negative electrode was fabricated in the same manner as in Example 1, except that a recess-and-projection transfer material obtained by forming recesses having a diameter of 1.0 μm and a depth of 20 μm on a surface of a Ni base material using the electrolytic method was used as the recess-and-projection transfer material, and the lithium metal secondary battery was fabricated using the negative electrode.

### Comparative Example 2

In the fabrication of the negative electrode, the negative electrode was fabricated in the same manner as in Example 1, except that a recess-and-projection transfer material obtained by forming recesses having a diameter of 1.0 μm and a depth of 12 μm on a surface of a Ni base material using the electrolytic method was used as the recess-and-projection transfer material, and the lithium metal secondary battery was fabricated using the negative electrode.

### Comparative Example 3

In the fabrication of the negative electrode, the negative electrode was fabricated in the same manner as in Example 1, except that a recess-and-projection transfer material obtained by forming recesses having a diameter of 1.0 μm and a depth of 5 μm on a surface of a Ni base material using the electrolytic method was used as the recess-and-projection transfer material and except that the rate of compression of the recess-and-projection forming laminate was 15%, and the lithium metal secondary battery was fabricated using the negative electrode.

The material for the base material of the recess-and-projection transfer material, processing method for forming the recesses, the diameter and depth of the recesses, the organic solvent (mold release agent), and pressing conditions (pressure and rate of compression) used in the fabrication of the negative electrode in Examples 1 to 4 and Comparative Examples 1 to 3 are shown in Table 1 below.

### Evaluation

The negative electrodes fabricated in Examples 1 to 4 and Comparative Examples 1 to 3 were evaluated in the following manner. The results are shown in Table 2.
1) Adhesion of Li to the recess-and-projection transfer material was visually observed. In a case in which there was no adhesion of Li, it means that there was no loss of the Li foil of the negative electrode.
2) The negative electrode was arranged on a flat plate, and an occurrence of a curl having a cross section curved into a semi-circular shape was visually observed. Note that in the fabrication of the lithium metal secondary battery, the separator and the positive electrode were laminated on the negative electrode with both ends of the negative electrode held with tweezers if a curl had occurred in the negative electrode. In a case in which a curl of the negative electrode did not occur, it means that there was no gap between the negative electrode and the flat plate, and the negative electrode was flat.
3) The above-described electrolytic solution was dropped onto the surface of the Li foil of the negative electrode to measure the angle of contact at 25° C. with respect to the electrolytic solution.

The voltage (OCV) of the lithium metal secondary battery before aging (immediately after fabrication) fabricated in Examples 1 to 4 and Comparative Examples 1 to 3 and an AC resistance were measured at 1 KHz. The results are shown in Table 2 below.

TABLE 1

| | | | | | Conditions for Manufacturing Negative | | |
|---|---|---|---|---|---|---|---|
| | | | | | Electrode | | |
| | Recess-and-Projection Transfer Material | | | | | Pressing Conditions | |
| | Material | | Shape of Recesses | | Organic Solvent | | Rate of |
| | for Base | Processing | Diameter | Depth | (Mold Release | Pressure | Compression |
| | Material | Method | (μm) | (μm) | Agent) | (MPa) | (%) |
| Example 1 | Ti | Laser | 15 | 12 | DEE | 25 | 30 |
| | | Machining | | | | | |
| Example 2 | Ti | Laser | 15 | 8 | DEE | 25 | 30 |
| | | Machining | | | | | |
| Example 3 | Ti | Laser | 15 | 4 | DEE | 25 | 30 |
| | | Machining | | | | | |
| Example 4 | Ti | Laser | 15 | 4 | None | 25 | 30 |
| | | Machining | | | | | |
| Comparative | Ni | Electrolytic | 1.0 | 20 | DEE | 25 | 30 |
| Example 1 | | Method | | | | | |
| Comparative | Ni | Electrolytic | 1.0 | 12 | DEE | 25 | 30 |
| Example 2 | | Method | | | | | |
| Comparative | Ni | Electrolytic | 1.0 | 5 | DEE | 12.5 | 15 |
| Example 3 | | Method | | | | | |

TABLE 2

| | | | | Battery Properties | |
|---|---|---|---|---|---|
| | Evaluation of Negative Electrode | | | (before Aging) | |
| | Adhesion of Li to | | Angle of | | AC |
| | Recess-and-Projection | Occurrence | Contact | Voltage | Resistance |
| | Transfer Material | of Curl | (degrees) | (V) | (Ω) |
| Example 1 | Absent | Absent | 1 | 3.30 | 2.1 |
| Example 2 | Absent | Absent | 2 | 3.25 | 2.3 |
| Example 3 | Absent | Absent | 3 | 3.20 | 2.5 |
| Example 4 | Absent | Absent | 3 | 3.20 | 2.8 |
| Comparative | Present | Present | 5 | 3.30 | 2.1 |
| Example 1 | | | | | |
| Comparative | Present | Present | 7 | 3.30 | 2.3 |
| Example 2 | | | | | |
| Comparative | Present | Absent | 30 | 3.20 | 3.0 |
| Example 3 | | | | | |

The results in Tables 1 and 2 reveal that the negative electrodes of Examples 1 to 4 fabricated using recess-and-projection transfer materials in which the recesses of the recess-and-projection transfer material have diameters and depths falling within the scope of the present invention have no loss of the Li foil, are flat, and have excellent assembling performance. It is also revealed that wettability with respect to the electrolytic solution is high because of high voltage and low resistance. Moreover, wettability of the negative electrode is stabilized early by combining the negative electrode having an angle of contact of 20 degrees with respect to the electrolytic solution and the separator having an angle of contact of 30 degrees or less with respect to the electrolytic solution and using the negative electrode in which recesses and projections are formed by the manufacturing method of the present invention. Shortening of an electrolytic solution impregnating time during aging and improvement of initial charging rate can thereby be achieved, which enables an aging time to be shortened. Even if aging is shortened, it can be expected that the lithium metal secondary battery after aging has improved yield.

### EXPLANATION OF REFERENCE NUMERALS

1 electrode laminate
10 positive electrode
11 positive electrode current collector
12 positive electrode active material layer
20 negative electrode
21 negative electrode current collector
22 lithium-containing metal layer
20a negative electrode material laminate
21a negative electrode current collector material
22a lithium-containing metal layer material
20b elongated negative electrode material laminate sheet
21b elongated negative electrode current collector material sheet
22b elongated lithium-containing metal layer material sheet
20c elongated negative electrode material laminate sheet having recesses and projections
21c elongated negative electrode current collector material sheet
22c elongated lithium-containing metal layer material sheet having recesses and projections
30 separator
100 apparatus for manufacturing negative electrode for lithium metal secondary battery
110 press roll
120 recess-and-projection forming laminate
121 release plate
122 plate-shaped recess-and-projection transfer material
200 apparatus for manufacturing negative electrode for lithium metal secondary battery
210 roll-shaped recess-and-projection transfer material

What is claimed is:

1. A method for manufacturing a negative electrode for a lithium metal secondary battery, the method comprising pressing a recess-and-projection transfer material in which a plurality of recesses having a diameter falling within a range of 2 μm or more and 20 μm or less and a depth of 12 μm or less are arranged against a surface of a laminate on a lithium-containing metal layer side, the laminate including a negative electrode current collector and a lithium-containing metal layer arranged on at least one of surfaces of the negative electrode current collector, and forming recesses and projections on a surface of the lithium-containing metal layer.

2. The method for manufacturing a negative electrode for a lithium metal secondary battery according to claim 1, wherein the recesses of the recess-and-projection transfer material have a diameter falling within a range of 2 μm or more and 15 μm or less.

3. The method for manufacturing a negative electrode for a lithium metal secondary battery according to claim 1, wherein the recesses have a conical or semispherical shape.

4. The method for manufacturing a negative electrode for a lithium metal secondary battery according to claim 1, wherein the recess-and-projection transfer material is formed of any of Al, Ti, Ni, W, and carbon.

5. The method for manufacturing a negative electrode for a lithium metal secondary battery according to claim 1, wherein a relationship of D≤t−2 is satisfied where t (unit: μm) represents a thickness of the lithium-containing metal layer, and D (unit: μm) represents the depth of the recesses.

6. The method for manufacturing a negative electrode for a lithium metal secondary battery according to claim 1, wherein when the recess-and-projection transfer material is pressed against the surface on the lithium-containing metal layer side, an organic solvent or a structure is interposed between the surface on the lithium-containing metal layer side and the recess-and-projection transfer material.

7. The method for manufacturing a negative electrode for a lithium metal secondary battery according to claim 1, wherein
the recess-and-projection transfer material is a plate-shaped body, and
the recesses are arranged on at least one of surfaces of the plate-shaped body.

8. The method for manufacturing a negative electrode for a lithium metal secondary battery according to claim 1, wherein
the recess-and-projection transfer material is a roll-shaped body, and
the recesses are arranged on at least part of a surface of the roll-shaped body.

9. The method for manufacturing a negative electrode for a lithium metal secondary battery according to claim 1, wherein
the lithium-containing metal layer includes lithium-containing metal layers, and the laminate has the lithium-containing metal layers laminated on both surfaces of the negative electrode current collector, respectively, and
the recess-and-projection transfer material includes recess-and-projection transfer materials, and the recess-and-projection transfer materials are simultaneously pressed against the lithium-containing metal layers laminated on both the surfaces of the negative electrode current collector, respectively.

10. The method for manufacturing a negative electrode for a lithium metal secondary battery according to claim 1, wherein a pressure with which the recess-and-projection transfer material is pressed against the surface on the lithium-containing metal layer side falls within a range of 5 MPa or more and 25 MPa or less.

11. A negative electrode for a lithium metal secondary battery, the negative electrode being a laminate including a negative electrode current collector and a lithium-containing metal layer arranged on at least one of surfaces of the negative electrode current collector, wherein
the lithium-containing metal layer has, on a surface thereof, projections having a diameter falling within a range of 2 μm or more and 20 μm or less and a height of 12 μm or less and has an angle of contact at 25° C. of 20 degrees or less with respect to a liquid having a viscosity at 25° C. of 5 mPas or more and 12 mPaS or less.
